(19) United States
(12) Patent Application Publication
(10) Pub. No.: US 2013/0342115 A1
(43) Pub. Date: Dec. 26, 2013

(54) LIGHT-EMITTING DEVICE

(71) Applicant: GIO Optoelectronics Corp., Tainan City (TW)

(72) Inventor: Wu-Chang Yang, Tainan City (TW)

(21) Appl. No.: 13/923,387

(22) Filed: Jun. 21, 2013

(30) Foreign Application Priority Data
Jun. 26, 2012 (TW) 101122883

(51) Int. Cl. H05B 33/08

(52) U.S. Cl. CPC H05B 33/08
USPC 315/185 R

(57) ABSTRACT

A light-emitting device is connected with an alternating current (AC) power and includes a first light-emitting module and a second light-emitting module. The first light-emitting module is electrically connected with the AC power and has a first light-emitting unit and a first bypass unit which is in parallel connection with the first light-emitting unit. The second light-emitting module is in series connection with the first light-emitting module and has a first connection terminal, a second connection terminal and n second light-emitting units which are connected in series between the first and second connection terminals. There are n−1 third connection terminals configured between the n second light-emitting units. Each of the n−1 third connection terminals and the second connection terminal are connected to the first connection terminal through a second bypass unit.

### CROSS REFERENCE TO RELATED APPLICATIONS

This Non-provisional application claims priority under 35 U.S.C. §119(a) on Patent Application No(s). 101122883 filed in Taiwan, Republic of China on Jun. 26, 2012, the entire contents of which are hereby incorporated by reference.

### BACKGROUND OF THE INVENTION

1. Field of Invention

The invention relates to a light-emitting device and, in particular, to an LED device.

2. Related Art

A light-emitting diode (LED) is a semiconductor component, and used to be a light source of an indicator or an outdoor display penal. Compared with a conventional light source, the LED has the advantages of a higher luminous efficiency, longer lifetime, and a better physical robustness, so that it has been widely used in many electronic products.

The control methods for a light-emitting device with light-emitting diodes as a light source generally include a constant voltage control and a constant current control. Please refer to FIGS. 1A and 1B, which are schematic views of the light-emitting devices with a constant voltage control and a constant current control, respectively.

As shown in FIG. 1A, a light-emitting device 1a comprises a light-emitting module 11, a capacitor 12, a plurality of resistors 13 and a constant voltage power source 14. For making the signal inputted into the light-emitting diode becomes a constant voltage signal, the capacitors with high capacitance or a sophisticated rectifier circuit must be provided to achieve the effect of stabilizing the voltage. Therefore, the manufacturing cost of the light-emitting device 1a will be increased.

Although the constant voltage control has a simpler circuitry design, it cannot provide a stable current output. Because a light-emitting diode emits light by the combination of electrons and holes to release the energy in a form of photons, changes of the current may greatly affect the luminous characteristics of light-emitting diodes. In other words, the constant voltage control can not precisely control the luminous characteristics of light-emitting diodes.

In addition, as shown in FIG. 1B, a light-emitting device 1b comprises a light-emitting module 11, a capacitor 12, and a constant current power source 15. Although the conventional constant current control can provide a stable current to the light-emitting diode, the constant current power source 15 has to absorb the power variation resulted from the change of input voltage in order to stabilize the current. As a result, additional power loss is therefore occurred.

However, either the light-emitting device 1a or the light-emitting device 1b needs a power supply unit that can stably provide power or has to be configured with a unit that can efficiently stabilize the voltage or current. When the power input from an external power source changes, the conventional light-emitting device with constant voltage or current control is not capable of in response to the change of the external power source to achieve the result of being driven by a variable power source.

Therefore, it is one of the important issues to provide a light-emitting device that can be in response to changes of external power source and has more lighting stages, for achieving the result of being driven by an adjustable power supply and having a higher efficiency of power-usage.

### SUMMARY OF THE INVENTION

To achieve the objective mentioned above, a light-emitting device according to the present invention connects with an AC power source, and comprises a first light-emitting module and a second light-emitting module. The first light-emitting module electrically connects with the AC power source and comprises a first light-emitting unit and a first bypass unit which is in parallel connection with the first light-emitting unit. The second light-emitting module is in series connection with the first light-emitting module, and comprises a first connection terminal, a second connection terminal and n second light-emitting units that are in series connection between the first connection terminal and the second connection terminal. There are n−1 third connection terminals configured between the n second light-emitting units. Each of the n−1 third connection terminals and the second connection terminal individually connect with the first connection terminal through a second bypass unit.

According to one aspect of the present invention, the light-emitting device further comprises a rectifier having an input terminal electrically connected with the AC power and an output terminal electrically connected with the first light-emitting module and the second light-emitting module.

According to another aspect of the present invention, the light-emitting device further comprises a current control circuit. The current control circuit, the first light-emitting module, and the second light-emitting module form a series loop which is electrically connected with the AC power.

According to another aspect of the present invention, the current control circuit further comprises a constant power source, an impedance component, or a current limiter.

According to another aspect of the present invention, the light-emitting device further comprises a control module. The control module has a first control unit electrically connected with the first bypass unit. The first control unit controls the first bypass unit so as to control the light emission of the first light-emitting unit.

According to another aspect of the present invention, the control module further comprises n second control units. Each of the n second control units is electrically connected with corresponding one of the second bypass units for controlling the light emission of the n second light-emitting units.

According to another aspect of the present invention, the second light-emitting module and the first light-emitting module have a junction located at the first connection terminal or at the second connection terminal. The first control unit detects the voltage at the junction so as to control the first bypass unit accordingly. Each of the second control units detects the voltage of the first connection terminal, the second connection terminal, or the corresponding one of the n−1 third connection terminal so as to control the second bypass units accordingly.

According to another aspect of the present invention, each of the first light-emitting unit and the second light-emitting units comprises at lease one light-emitting diode.

According to another aspect of the present invention, each of the first light-emitting unit and the second light-emitting unit has a threshold voltage. The threshold voltage of the first light-emitting unit is lower than that of the second light-emitting unit.

According to another aspect of the present invention, the threshold of the first light-emitting unit substantially equals to half of the threshold voltage of one of the second light-emitting unit.

According to another aspect of the present invention, each of the second light-emitting units has a plurality of light-emitting diodes connected in series of the same amount.

According to another aspect of the present invention, the first control unit controls the first bypass unit according to the potential difference between a first reference voltage and the voltage at the junction located at the first connection terminal or at the second connection terminal. Each of the second control units individually controls each of the second bypass units according to the potential difference between the corresponding one among n second reference voltages and the voltage of the first connection terminal, the second connection terminal, or the corresponding one among the third connection terminals.

According to another aspect of the present invention, the second control unit controls the corresponding second bypass unit to be not conducted and to make the corresponding second light-emitting unit emit light when the absolute voltage between the ground terminal and the first connection terminal, the second connection terminal, or the corresponding one among the n−1 third connection terminal, is greater than the absolute value of the second reference voltage to the ground terminal. When the absolute voltage of the ground terminal between the first connection terminal, the second connection terminal, or the corresponding one among the n−1 third connection terminals is lower than the absolute value of the second reference voltage to the ground terminal, the second control unit controls the corresponding second bypass unit to be conducted and to make the corresponding second light-emitting unit not emit light.

According to another aspect of the present invention, the light-emitting device further comprises a third light-emitting module in series connection with the first light-emitting module. The third light-emitting module has a third light-emitting unit and a third bypass unit in parallel connection with the third light-emitting unit. The third light-emitting module and the first light-emitting module have a junction which is a fourth connection terminal.

According to another aspect of the present invention, each of the first light-emitting unit and the third light-emitting unit has a threshold voltage, and the threshold voltage of the third light-emitting unit is lower than that of the first light-emitting unit.

According to another aspect of the present invention, control module further comprises a third control unit configured corresponding to the third bypass unit. The third control unit detects the voltage at the fourth connection terminal and controls the third bypass unit accordingly so as to control the light emission of the third light-emitting unit.

According to another aspect of the present invention, the third control unit controls the third bypass unit according to the potential difference between the voltage at the fourth connection terminal and a third reference voltage.

To sum up, according to the light-emitting device of the present invention, the first light-emitting module comprises a first light-emitting unit and a first bypass unit in parallel connection with the first light-emitting module. The second light-emitting module is in series connection with the first light-emitting module and comprises a first connection terminal, a second connection terminal and n second light-emitting units in series connection between the first connection terminal and the second connection terminal. There are n−1 third connection terminals configured between the n second light-emitting units. The second connection terminal and the n−1 third connection terminals are individually connected with the first connection terminal through a second bypass unit. Accordingly, when the voltage of the AC power electrically connected with the light-emitting device increases, and because the voltages at the first connection terminal, the second connection terminal, and the third connection terminal may change in response to the variation of the reference voltage of the preceding light-emitting unit, the light-emitting device therefore has more lighting stages, achieves the objective of being driven by the variable power, and may use the power more efficiently.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A and 1B are schematic diagrams showing conventional light-emitting devices of constant voltage and of constant current, respectively

FIG. 2 is a schematic diagram of a light-emitting device according to one preferred embodiment of the present invention; and

FIGS. 3A to 3E are schematic diagrams of light-emitting devices each according to one another preferred embodiment of the present invention.

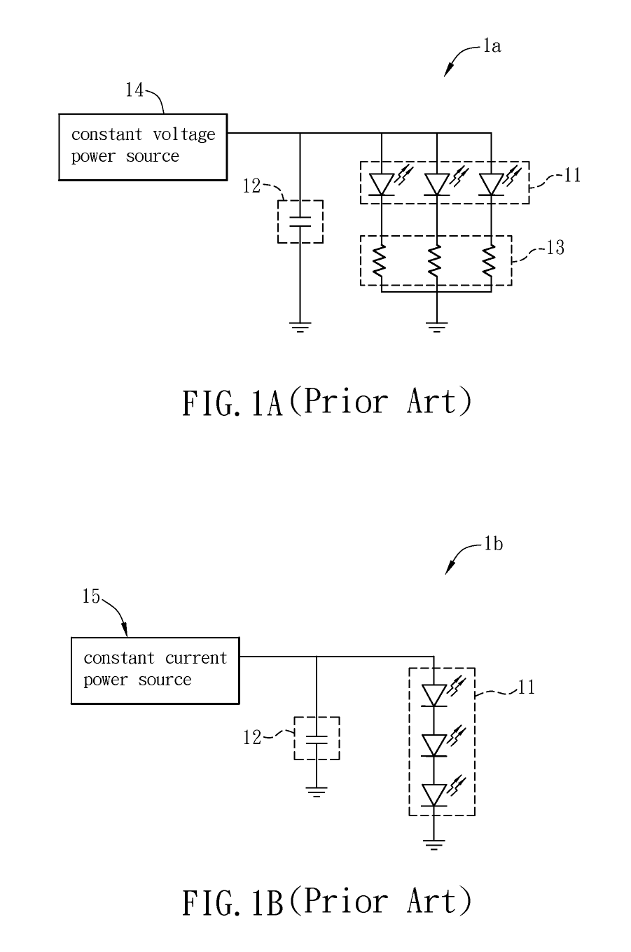

### DETAILED DESCRIPTION OF THE INVENTION

The present invention will be apparent from the following detailed description, which proceeds with reference to the accompanying drawings, wherein the same references relate to the same elements.

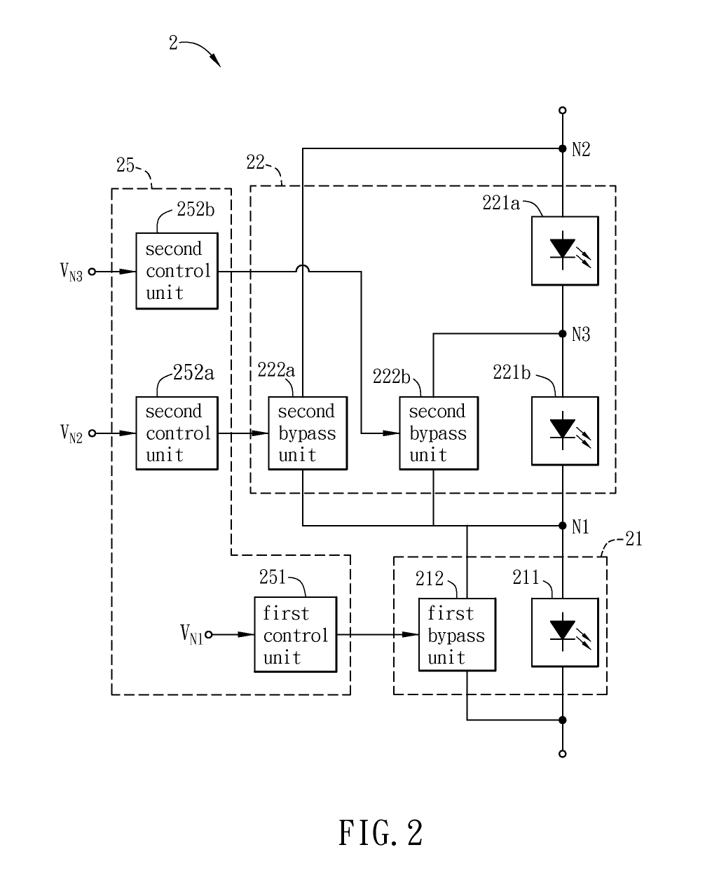

Please refer to FIG. 2, which is a schematic diagram showing a light-emitting device 2 of the present invention. The light-emitting device 2 of the present invention can be applied in the fields including, but not being limited to, mobile communication, lighting of transportation vehicles, ordinary indoor and outdoor illumination, and being a light source of a street lamp, advertising board, or a monitor.

The light-emitting device 2 is connected with an alternating current (AC) power (not shown here), and comprises a first light-emitting module 21 and a second light-emitting module 22. The electrical power received by the light-emitting device 2 can be from an adjustable voltage power supply. In a practical use, the adjustable voltage power supply can be an AC voltage supply or a direct current (DC) voltage supply and the level of voltage can be adjusted periodically or randomly as time passes, which means a non-stable voltage. The aforementioned AC voltage power supply can be the well-known mains electricity (i.e., AC power from 90V to 250V) or the AC power output by an electricity converter. In addition, the aforementioned DC voltage power supply can be a voltage power generated from cells, batteries, or from an AC voltage through a rectifier. The level of output voltage of the cell and battery may vary with the increasing time of usage. In addition, there is still ripple in the DC voltage generated from a rectifier. Therefore, the voltage level of such kind of DC voltage may still vary with the time.

The first light-emitting module 21 and the second light-emitting module 22 are connected in series and can be electrically connected with the AC power. The first light-emitting module 21 has a first light-emitting unit 211 and a first bypass unit 212. The first light-emitting unit 211 and the first bypass unit 212 are connected in parallel. In addition, the second light-emitting module 22 has a first connection terminal N1, a second connection terminal N2 and n second light-emitting units in series connection between the first connection terminal N1 and the second connection terminal N2. The first light-emitting module 21 and the second light-emitting module can be connected through the first connection terminal N1 or the second connection terminal N2. In the present embodiment, as shown in FIG. 2, the second light-emitting module 22 is connected with the first light-emitting module 21 through the first connection terminal N1, and the other terminal of the second light-emitting module 22 is the second connection terminal N2. The second connection terminal N2 is the terminal through which the electric current flows into the second light-emitting module 22, and the first connection terminal is the terminal through which the electric current flows out the second light-emitting module 22.

There are n−1 third connection terminals N3 configured between the n second light-emitting units, and each of n−1 third connection terminals N3 and the second connection terminal N2 is individually connected with the first connection terminal N1 through a second bypass unit. In this embodiment, the second light-emitting module 22 is exemplary to have two second light-emitting units 221a and 221b, so the amount of the third connection terminal N3 is one. The second light-emitting units 221a and 221b are connected in series. One terminal of the second light-emitting unit 221a is the second connection terminal N2 and the second light-emitting unit 221a is connected with the second light-emitting unit 221b through the third connection terminal N3. Each of the second light-emitting units 221a and 221b and the first light-emitting unit 211 may have at least one light-emitting diode, including but not limiting to an alternating current light-emitting diode (AC LED).

In addition, the light-emitting device 2 may further comprise a control module 25. The control module 25 has a first control unit 251 and n second control units (n is a positive integer that is greater than or equals to 2). In the present embodiment, control module 25 is exemplary to have a first control unit 251 and second control units 252a and 252b which are correspondingly configured to the second bypass units 222a and 222b, respectively.

The first control unit 251 is correspondingly configured to and electrically connected with the first bypass unit 212. The first control unit 251 is capable of controlling the first bypass unit 212 so as to modulate the current passing through the first light-emitting unit 211 which is in parallel connection with the first bypass unit 212. More detailed, the first control unit 251 detects the voltage (represented as V_{N1}) at the first connection terminal, and accordingly control the first bypass unit 212 to be conducted or cut off. Therefore, the emission of light of the first light-emitting unit is also controlled.

Meanwhile, the second control units 252a and 252b are electrically connected with the corresponding second bypass units 222a and 222b, respectively, for controlling the light-emission of the second light-emitting units 221a and 221b, respectively. In other words, in the present embodiment, the second control unit 252a is correspondingly configured to and electrically connected with the second bypass unit 222a, and the second control unit 252b is correspondingly configured to and electrically connected with the second bypass unit 222b. The second bypass units 222a and 222b have a common terminal which is the first connection terminal N1.

The second control unit 252a detects the voltage (represented as V_{N2}) at the second connection terminal N2 to control the second bypass unit 222a, so as to modulate the current passing through the second light-emitting unit 221a which is electrically in parallel connection with the second bypass unit 222a. The emission of light of the second light-emitting unit 221a is therefore controlled. The second control unit 252b detects the voltage (represented as V_{N3}) at the third connection terminal N3 to control the second bypass unit 222b, so as to modulate the current passing through the second light-emitting unit 221b which is in parallel connection with the second bypass unit 222b. And, the light-emission of the second light-emitting unit 221b is also therefore controlled.

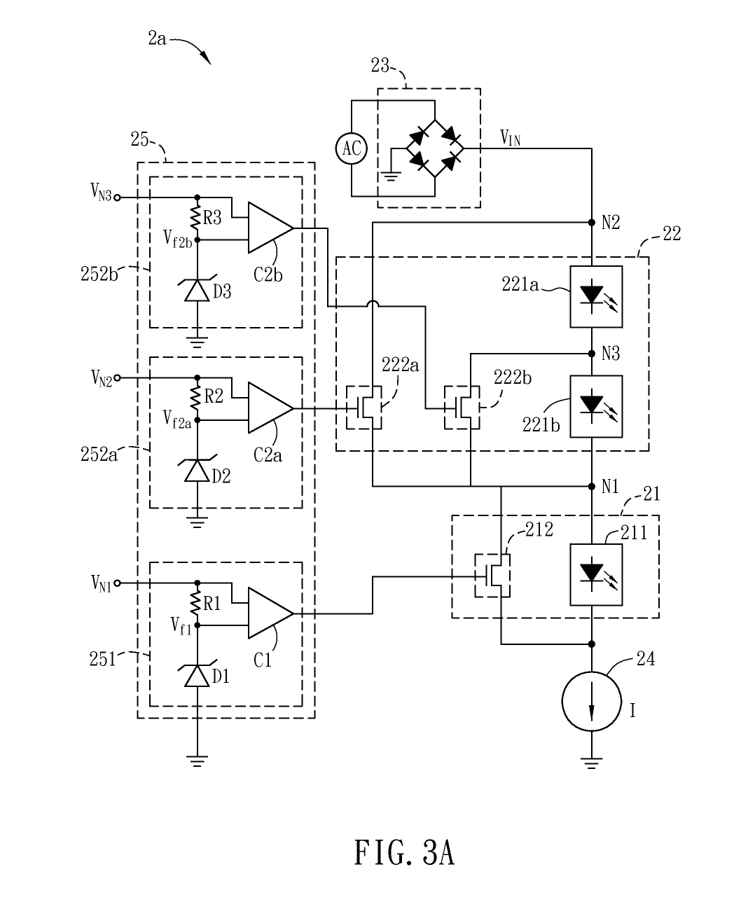

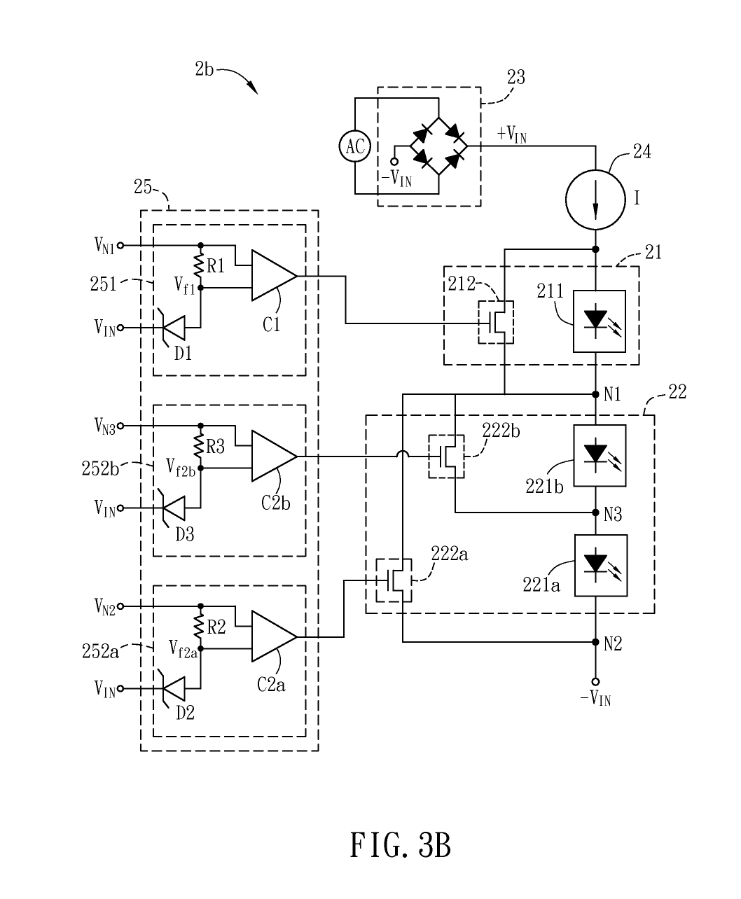

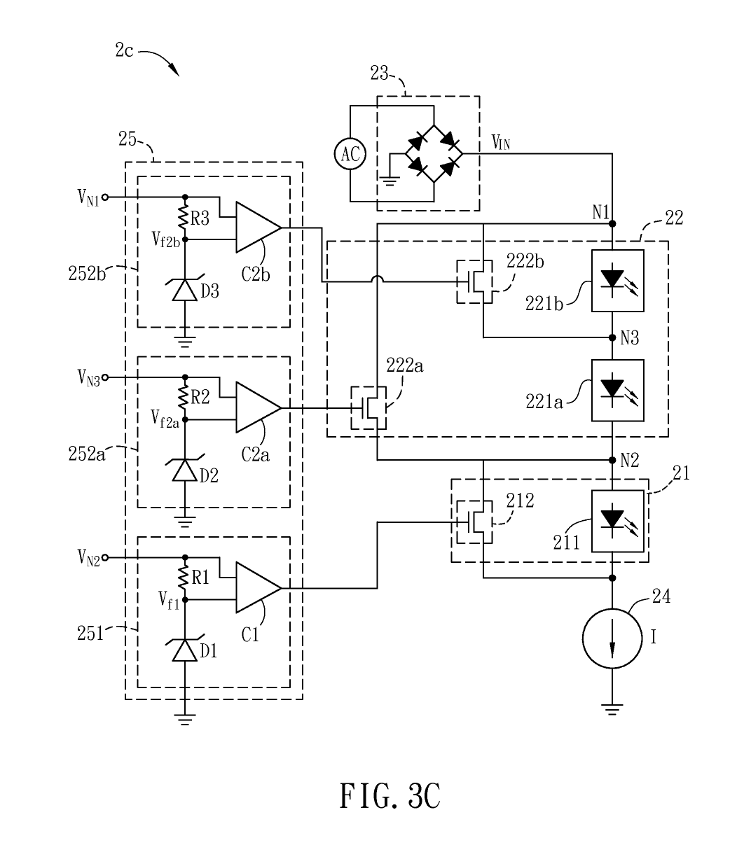

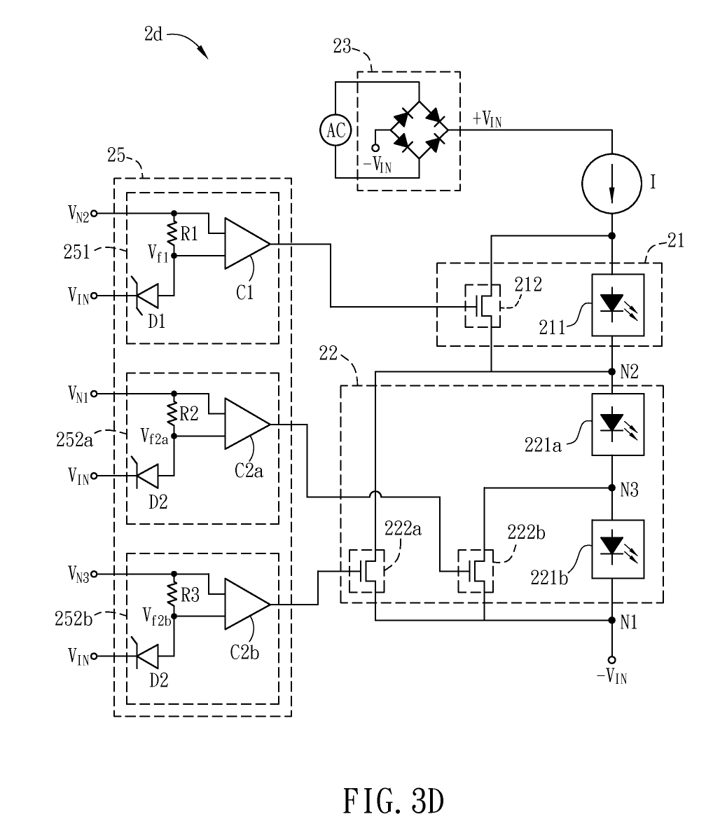

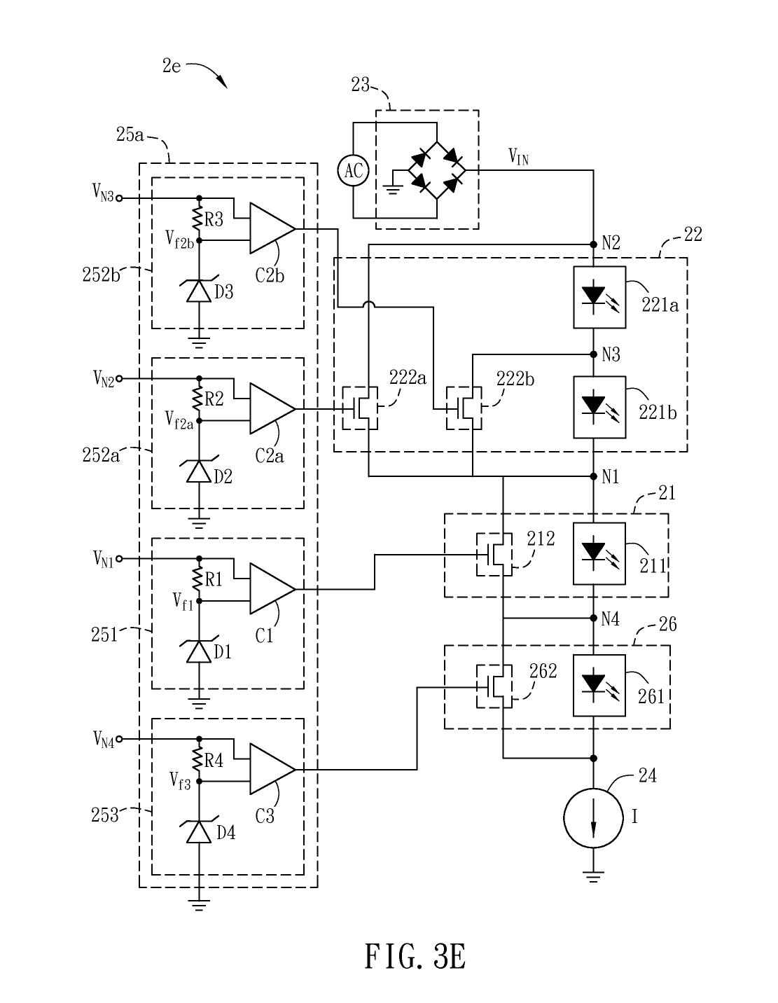

Then, please refer to FIG. 3A for explaining the light-emitting device of the present invention in more detail. In the present embodiment, the second light-emitting module of the light-emitting device 2a is still exemplary to include, but not be limited to, two second light-emitting units 221a and 221b.

Each of the first light-emitting unit 211 and the second light-emitting units 221a and 221b may have a plurality of light-emitting diodes in series or in parallel connection with each other. In addition, each of the first light-emitting unit 211 and the second light-emitting units 221a and 221b has a threshold voltage. The threshold voltage of the first light-emitting unit 211 is lower than that of the second light-emitting unit 221a or 221b. Here, a threshold voltage is the minimal voltage to make a light-emitting unit in conductance. When the voltage across the two terminals of a light-emitting unit is greater than or equal to its threshold voltage, the light-emitting unit is therefore lit. Specifically, if every light-emitting diode has equal power, the amount of the light-emitting diodes of the first light-emitting unit 211 in series connection is lower than that of either the second light-emitting unit 221a or 221b in series connection.

The threshold voltages of the second light-emitting units 221a and 221b are equal. The threshold voltage of the first light-emitting unit 211 is substantial equal to half of the threshold voltage of the second light-emitting unit 221a or 221b. In other words and using the light-emitting diodes of equal power in series connection as an example, the amount of the light-emitting diodes in series connection of the second light-emitting units 221a and 221b are equal, and the amount of the light-emitting diodes in series connection of the first light-emitting 211 is half of that of the second light-emitting unit 221a or 221b. Here, the threshold voltage of the first light-emitting unit 211 is exemplary to be 8V (may be two light-emitting diodes of 4V in series connection) and the threshold voltages of the second light-emitting units 221a and 221b are exemplary to be 16V (may be four light-emitting diodes of 4V in series connection). However, in a practical operation, other amounts of the light-emitting diodes can certainly be used to result in different threshold voltage according to the actual requirement.

The first control unit 251 controls the first bypass unit 212 according to the potential difference between a reference voltage V_{f1} and the voltage V_{N1} at the first connection terminal N1. The first control unit 251 comprises a comparator C1 which has two comparative input terminals and one comparative output terminal. The comparator C1 is connected with the first connection terminal N1 and the first reference voltage V_{f1} each through one of the comparative input terminals respectively, and compares the voltage at the first connection terminal N1 with the value of the reference voltage V_{f1}. The comparator C1 is electrically connected with the first bypass unit 212 through the comparative output terminal to control the first bypass unit 212. In addition, a Zener diode D1 may be configured to the electrical junction between the comparative input terminal and the first reference voltage V_{f1}. The choice of the design of the Zener diode D1 may depend on an actual requirement. For example, the choice is made according to the threshold voltage of the first light-emitting unit 211. In addition, a resistor R1 is configured between the two comparative input terminals of the comparator C1 to provide a path of the operative current of the Zener diode D1.

The second control unit controls the second bypass unit 222a according to the potential difference between the voltage V_{N2} at the second connection terminal N2 and a second reference voltage V_{f2a}. The second control unit 252b controls the second bypass unit 222b according to the potential difference between the voltage V_{N3} at the third connection terminal and another second reference voltage V_{f2b}. Each of the second control units 252a and 252b comprises a comparator C2a and C2b, respectively. Each of the comparator C2a and C2b has two comparative input terminals and one comparative output terminal. The comparator C2a is electrically connected with the second connection terminal N2 and the second reference voltage V_{f2a} each through one of the comparative input terminals, and compares the voltage at the second connection terminal N2 with the value of the second reference voltage V_{f2a}. The comparator C2a is electrically connected with the second bypass unit 222a through the comparative output terminal to control the second bypass unit 222a. In addition, the comparator C2b is electrically connected with the third connection terminal N3 and the second reference voltage Vf2b each through one of the comparative input terminals, and compares the voltage at the third connection terminal N3 with the value of the second reference voltage V_{f2b}. The comparator C2b is connected with the second bypass unit 222b through the comparative output terminal to control the second bypass unit 222b. A Zener diode D2 is configured to the electrical junction between the second reference voltage V_{f2b} and the comparative input terminal of the comparator C2a, and a Zener diode D3 is configured to the electrical junction between the second reference voltage V_{f2b} and the comparative input terminal of the comparator C2b. The choice of the designs of the Zener diodes D2 and D3 may depend on an actual requirement. For example, the choice of the designs of the Zener diodes D2 and D3 is made according to the threshold voltage of the second light-emitting units 222a and 222b, respectively. In the present embodiment, the threshold voltages of the second light-emitting unit 222a and 222b are equal, and the second reference voltage input the two comparators C2a and C2b, respectively, may be also equal. In addition, a resistor R2 is also configured between the two comparative output terminals of the comparator C2a to provide a path of the operative current of the Zener diode D2, and a resistor R3 is configured between the two comparative output terminals of the comparator C2b to provide a path of the operative current of the Zener diode D3. In a practical operation, each of the first bypass unit 212 and the second bypass units 222a and 222b may comprise a transistor switch, such as a bipolar junction transistor (BJT) or a field-effect transistor (FET). In addition, each of the comparator C1, C2a, and C2b can be a component that constitutes the transistor switch. Each of the reference voltages V_{f1}, V_{f2a}, and V_{f2b} is an absolute value of voltage and correlated with the breakdown voltage of the Zener diodes D1, D2, and D3 that is chosen to use, respectively. The reference voltages Vf1, Vf2a, and Vf2b can be the breakdown voltages of the Zener diode D1, D2 and D3, respectively, and, for example, can be equal to the minimal operative voltage of current control circuit 24 plus the threshold voltage of the light-emitting unit that is correspondingly controlled.

In addition, the light-emitting device 2a may further comprise a rectifier 23. The rectifier 23 is electrically connected with the AC power through its input terminal and is electrically connected with the first light-emitting module 21 and the second light-emitting module 22 through its output terminal. Here, the rectifier 23 can be a bridge rectifier, and electrically connected with second connection terminal N2 of the second light-emitting module 22 through its output terminal. In FIG. 3A, the voltage at the output terminal of the rectifier 23 is represented by V_{IN}, and V_{IN} is equal to V_{N2}. Here, V_{IN} is a variable voltage that varies from zero to a peak value.

In addition, the light-emitting device 2a may further comprise a current control circuit 24. The current control circuit 24, the first light-emitting module 21 and the second light-emitting module 22 together form a series loop which is electrically connected with the AC power. Here, the current control circuit 24 is connected with the first light-emitting module 21 through the other terminal of the light-emitting module opposite to the first connection terminal N1. The other terminal of the current control circuit 24 is a ground terminal. For example, the current control circuit may comprise a constant current source, an impedance component, or a current limiter, and the impedance component can be a resistor, a capacitor, or an inductor. In the present embodiment, the current control circuit 24 is a controllable constant current source. Here, for example, the minimal operative voltage of the current control circuit 24 is 2V, and the absolute voltage of the reference voltage V_{f1} to the ground terminal can therefore be 10V (2V+8V), and the absolute voltage of the second reference voltage V_{f2a} and V_{f2b} can both be 18V (2V+16V).

When the light-emitting device 2a is just connected with the AC power, the absolute value of the voltage V_{N1} at the first connection terminal N1, the voltage V_{N2} at the second connection terminal N2, and the voltage V_{N3} at the third connection terminal N3 to the ground voltage are lower than that of the first reference voltage V_{f1} and the second reference voltages V_{f2a} and V_{f2b} to the ground voltage, respectively. Therefore, each of the first bypass unit 212, the second bypass unit 222a and 222b is conducted for being in a short circuit. Meanwhile, the first light-emitting unit 211 and the second light-emitting units 221a and 221b are not lit.

When the voltage of the AC power increases and the V_{IN} rectified and output by the rectifier 23 becomes greater than the threshold voltage (8V) of the first light-emitting unit 211 plus the minimal operative voltage (2V) of the current control circuit 24 (i.e., V_{IN}>8V+2V=10V), the absolute value of the voltage V_{N1} at the first connection terminal N1 to the ground terminal is greater than that of the first reference voltage V_{f1} to the ground terminal. The first bypass unit 212 is therefore cut off and not conducted. Meanwhile, the first light-emitting unit 211 is lit to emit light.

When the level of the V_{IN} continuously increases to become greater than the threshold voltage (16V) of the second light-emitting unit 221a plus the minimal operative voltage (2V) of the current control circuit 24 (i.e., V_{IN}>16V+2V=18V), the absolute value of the voltage at the second connection terminal N2 to the ground terminal is greater than that of the second reference voltage V_{f2a} to the ground terminal (>18V). The second bypass unit 222a is therefore cut off and not conducted, and the second light-emitting unit 221a is lit. Meanwhile, as when the second light-emitting unit 221a is turned on, the voltage at the third connection terminal N3 is equal to that at the first connection terminal N1. And, the voltage V_{N1} at the first connection terminal N1 will be lower than the first reference voltage (<10V) because the second bypass unit 222a is not conducted. Therefore, in such circumstances, the first bypass unit 212 will be conducted again to make the first light-emitting unit 211 become extinguished.

When the voltage level of V_{IN} continuously increases to become greater than the threshold voltage of the first light-emitting unit 211 plus the threshold voltage of the second light-emitting unit 221a and the minimal operative voltage of the current control circuit 24 (i.e., V_{IN}>16V+8V+2V=26V), the absolute value of the voltage at the second connection terminal to the ground terminal is greater than that of the second reference voltage V_{f2a} to the ground terminal (>18V). And, the absolute value (>28V−18V=10V) of the voltage level at the first connection terminal N1 to the ground is also greater than that of the first reference voltage V_{f1} to the ground terminal. Therefore, both the first bypass unit 212 and the second bypass unit 222a are not conducted to make the first light-emitting unit 211 and the second light-emitting unit 221a are lit at the same time.

When the voltage level of V_{IN} continuously increases to become greater than the summation of the threshold voltages of the second light-emitting units 221a and 221b plus the minimal operative voltage of the current control circuit 24 (i.e., V_{IN}>2V+16V+16V=34V), the absolute value of the voltage at the second connection terminal N2 to the ground terminal is greater than that of the second reference voltage V_{f2a} to the ground terminal (>18V). And, the absolute value of the voltage at the third connection terminal N3 to the ground terminal is also greater than that of the second reference voltage V_{f2b} to the ground terminal. The second bypass units 222a and 222b are not conducted to make the second light-emitting units to be lit. Meanwhile, because the second bypass units 222a and 222b are not conducted, the voltage level of V_{N1} at the first connection terminal N1 will then become lower than the first reference voltage V_{f1} (34V−16V−16V=2V<10V). Therefore, the first bypass unit 212 becomes conducted to make the first light-emitting unit 211 become extinguished again.

When the voltage level of V_{IN} continuously increases to become greater than the summation of the threshold voltages of the first light-emitting unit 211 and the second light-emitting units 221a and 221b plus the minimal operative voltage of the current control circuit 24 (i.e., V_{IN}>8V+16V+16V+2V=42V), the absolute value of the voltage at the second connection terminal N2 to the ground terminal is greater than that of the second reference voltage V_{f2a} to the ground terminal (>18V), and also greater than that of the second reference voltage V_{f2b} to the ground terminal (>18V). The second bypass units 222a and 222b are therefore not conducted to make the second light-emitting units 221a and 221b to be lit. Meanwhile, because the second bypass units 222a and 222b are not conducted, the voltage level of V_{N1} at the first connection terminal N1 is at least 10V (42V−16V−16V), which is greater than the first reference voltage V_{f1}. Therefore, the first bypass unit 212 is also not conducted to make the first light-emitting unit 211 become lit again.

To sum up, the lighting order of the light-emitting device 2a in response to the increasing of the input voltage is: first light-emitting unit 211, the second light-emitting unit 221a, the first light-emitting unit 211 together with the second light-emitting unit 221a, the second light-emitting unit 221a together with the second light-emitting unit 221b, and then the first light-emitting unit 211 together with the second light-emitting units 221a and 221b. In such lighting order, the first light-emitting unit 211 is bright, off, bright, off, in alternation. The second light-emitting units 221a and 221b are sequentially lit between the brightness and off of the first light-emitting unit 211.

Therefore, by the aforementioned hardware configuration, the first control unit 251 and the second control units 252a and 252b of the control module 25 are respectively detects the absolute value of the voltage at the first connection terminal N1, the second connection terminal N2, and the third connection terminal N3, to the ground terminal and the absolute value of the first reference voltage V_{f1} and the second reference voltage V_{f2a} and V_{f2b} to the ground terminal, in response to the variation of the threshold voltage of the first light-emitting unit 211 and the second light-emitting unit 221a and 221b. The first control unit 251 and the second control units 252a and 252b, through the first bypass unit 212 and the second bypass units 222a and 222b, respectively, correspondingly modulate the current passing through the first light-emitting unit 211 and the second light-emitting unit 221a and 221b which are in parallel connection with the first bypass unit 212 and the second bypass units 222a and 222b, respectively. In other words, the voltage at each of the connection terminals detected by the corresponding control units is affected by the voltage across the two terminals of another light-emitting unit when such light-emitting unit is bypassed or conducted. Therefore, each of the voltage at the first connection terminal N1, the second connection terminal N2, and the third connection terminal N3 is a floating voltage. And, the voltage at each connection terminals can be varied in response to the change of the reference voltage of its preceding light-emitting unit, in order to make the light-emitting device have more lighting stages, to achieve to be driven by a variable power source, and to be able to have a higher efficiency of power-usage. For a further mention, in the present embodiment, the amount of the light-emitting diodes connected in series of the second light-emitting units 221a and 221b are equal. The amount of the light-emitting diodes connected in series of the first light-emitting unit 211 is equal to half of the amount of the light-emitting diodes connected in series of either the second light-emitting unit 221a or 221b. It is therefore has a highest efficiency of power-usage.

Then, please refer to FIG. 3B, which is the schematic diagram of the light-emitting device according to another preferred embodiment of the present invention.

A major difference between the light-emitting device 2b and the light-emitting device 2a is that, in the light-emitting device 2b, an input terminal of the rectifier 23 is electrically connected with the AC power, and its output terminal (the voltage V_{IN}) is electrically connected with the current control circuit 24. In addition, the voltage at the output terminal is alternating (represented as V_{IN} and −V_{IN}). The voltage VIN is input into one terminal of the current control circuit 24, and the voltage −VIN is electrically connected with another input terminal of the rectifier 23 and the second connection terminal N2. The voltage V_{IN} is a positive voltage, and is connected with the current control circuit 24 and input into the first light-emitting module 21 and the second light-emitting module 22. In addition, the voltage −V_{IN} is a negative voltage, is input into the first light-emitting module 21 and the second light-emitting module 22 via the second connection terminal N2. In this embodiment, V_{IN} is as the reference ground terminal and −V_{IN} is a variable voltage.

In addition, one terminal of the first light-emitting module 21 is connected with the current control circuit 24 and the other terminal is electrically connected with the second light-emitting module 22. The connection terminal between the first light-emitting unit 211 and the second light-emitting unit 221b is the first connection terminal N1, which is also the common terminal of the second bypass units 222a and 222b. The other terminal of the second light-emitting module 22 (i.e., the second connection terminal N2) is connected with the voltage −V_{IN}.

In addition, a Zener diode is configured to the electrical junction where the comparative input terminal of the comparator C 1 is connected with first reference voltage V_{f1}. The other terminal of the Zener diode is connected with the output terminal (V_{IN}) of the rectifier. A Zener diode D2 is configured to the electrical junction between the second reference voltage V_{f2a} and the comparative input terminal of the comparator C2a, and a Zener diode D3 is configured to the electrical junction between the second reference voltage V_{f2b} and the comparative input terminal of the comparator C2b. Each of the other terminal of the Zener diodes D2 and D3 is individually connected with the output terminal (V_{IN}) of the rectifier 23.

Therefore, the rectifier 23 output a variable negative voltage to the light-emitting device 2b, and the light-emitting units of the light-emitting device 2b has the same lighting order as the light-emitting device 2a. Therefore, the light-emitting device 2b may also have the same lighting order as the light-emitting device 2a in response to the decreasing of the external voltage.

In addition, the process of lighting of the light-emitting device 2b, as well as its other technical features, can be referred to those of the light-emitting device 2a and therefore is not repeated here.

Then, please refer to FIG. 3C, which is the schematic diagram of the light-emitting device according to another preferred embodiment of the present invention.

A major difference between the light-emitting device 2c and the light-emitting device 2a is that, in the light-emitting device 2c, the first connection terminal N1 (i.e., the common terminal of the second bypass unit 222a and 222b) is connected with the output terminal of the rectifier 23, and the first light-emitting module 21 is connected with the second light-emitting module 22 through the second connection terminal N2. Here, the light-emitting device 2c has the same lighting order in response to the increasing of V_{IN} as the light-emitting device 2a.

In addition, the process of lighting of the light-emitting device 2c, as well as its other technical features, can be referred to those of the light-emitting device 2a and therefore is not repeated here.

In addition, please refer to FIG. 3D, which is the schematic diagram of the light-emitting device according to another preferred embodiment of the present invention.

A major difference between the light-emitting device 2d and the light-emitting device 2b is that, in the light-emitting device 2d, the first light-emitting module 21 is connected with the second light-emitting module 22 through the second connection terminal N2, and the other terminal of the second light-emitting module is the first connection terminal N1 which is the common terminal of the second bypass units 222a and 222b. Hence, the light-emitting device 2d has the same lighting order as the light-emitting device 2b.

In addition, the process of lighting of the light-emitting device 2d, as well as its other technical features, can be referred to those of the light-emitting devices 2b and 2a and therefore is not repeated here.

In addition, please refer to FIG. 3E, which is the schematic diagram of the light-emitting device according to another preferred embodiment of the present invention.

A major difference between the light-emitting device 2e and the light-emitting device 2 is that the light-emitting device 2e further comprises a third light-emitting module 26. The third light-emitting module 26 is in series connection with the first light-emitting module 21. The junction between the third light-emitting module 26 and the first light-emitting module 21 is a fourth connection terminal N4.

The third light-emitting module 26 comprises a third light-emitting unit 261 and a third bypass unit 262 which is in parallel connection with the third light-emitting unit 261. The third light-emitting unit 261 has a threshold voltage. The threshold voltage of the third light-emitting unit 261 is lower than that of the first light-emitting unit 211. In the present embodiment, the threshold voltage of the third light-emitting unit 261 is half of the threshold voltage of the first light-emitting unit 211. In other words, the amount of the light-emitting diodes connected in series of the third light-emitting unit 261 is half of the amount of the light-emitting diodes connected in series of the first light-emitting unit 211.

In addition, the control module 25a can further comprise a third control unit 253 that is correspondingly configured to the third bypass unit. The third control unit 253 can detect the voltage (V_{N4}) at the fourth connection terminal N4, and accordingly controls the third bypass unit 262, so as to control the emission of light of the third light-emitting unit 261.

The third control unit 253 can comprise a comparator C3, and the comparator C3 has two comparative input terminals and one comparative output terminal. The comparator C3 is electrically connected with the fourth connection terminal N4 and the third reference voltage V_{f3} each through one of the comparative input terminals, and electrically connected with the third bypass unit 262 through its comparative output terminal. In addition, a Zener diode D4 is also configure to the electrical junction between one comparative input terminal of the comparator C3 and the third reference voltage V. The choice of the design of the Zener diode D4 may be made according to the threshold voltage of the third light-emitting unit 261. In addition, a resistor R4 is configured between the two comparative input terminals of the comparator C3 to provide a path of the operative current of the Zener diode D4.

When the absolute value of the voltage at the fourth connection terminal to the ground terminal is greater than that of the reference voltage Vf3 to the ground terminal, the third control unit 253 controls the third bypass unit 262 to be cut off and not conducted, so as to make the third light-emitting unit emit light. On the other hand, when the absolute value of the voltage at the fourth connection terminal N4 to the ground terminal is lower than that of the third reference voltage Vf3 to the ground terminal, the third control unit 253 can control the third bypass unit to be conducted and to make the third light-emitting unit 261 not to emit light. Besides, other technical features of the light-emitting device 2e can be referred to those of the light-emitting device 2, and therefore are not repeated here.

In the present embodiment, the amount of the light-emitting diodes connected in series of the second light-emitting units 221a and 221b are equal. For example, both the second light-emitting units 221a and 221b have 4 light-emitting diodes connected in series. And, the amount of the light-emitting diodes connected in series of the first light-emitting unit 211 is half of the amount of the light-emitting diodes connected in series of either the second light-emitting unit 221a or 221b (for example, the light-emitting unit 211 can have two light-emitting diodes.). The amount of the light-emitting diodes connected in series of the first light-emitting unit 261 is half of the amount of the light-emitting diodes connected in series of the first light-emitting unit 211 (for example, the light-emitting unit 261 can have one light-emitting diode.). Therefore, the variation mode of the lighting number of the LEDs in the light-emitting device 2e is similar to a binary mode. The lighting order of the light-emitting device 2e is that: the third light-emitting unit 261 (one LED), the first light-emitting unit 211 (two LEDs), the third light-emitting unit 261 together with the first light-emitting unit 211 (total three LEDs), the second light-emitting unit 221a (four LEDs), the third light-emitting unit 261 together with the second light-emitting unit 221a (total five LEDs), the first light-emitting unit 211 together with the second light-emitting unit 221a (total six LEDs), the third light-emitting unit 261 together with the first light-emitting unit 211 and the second light-emitting unit 221a (total seven LEDs), the second light-emitting unit 221a together with the second light-emitting unit 221b (total eight LEDs), the third light-emitting unit 261 together with the second light-emitting units 221a and 221b (total nine LEDs), the first light-emitting unit 211 together with the second light-emitting units 221a and 221b (total ten LEDs), and the third light-emitting unit 261 together with the first light-emitting unit 211 and the second light-emitting units 221a and 221b (total eleven LEDs). Therefore, the lighting mode of the light-emitting device 2e is similar to a binary mode. The light-emitting device 2e hence has more lighting stages. Thereby, the light-emitting device 2e is capable of being in response to being driven by the AC power and therefore acquires higher efficiency of power-usage. The quantity of each light-emitting unit as mentioned above is just for instance. Users surely may change the quantity of each light-emitting unit according to his actual requirement, which results in different lighting number of the LEDs in the light-emitting device.

To sum up, the first light-emitting module of the light-emitting device according to the present invention comprises a first light-emitting unit and a first bypass unit that is in parallel connection with the first light-emitting unit. The second light-emitting module is in series connection with the first light-emitting module and has a first connection terminal, a second connection terminal and n second light-emitting units which are connected in series between the first and second connection terminals. There are n−1 third connection terminals configured between the n second light-emitting units. Each of the n−1 third connection terminals and the second connection terminal are connected to the first connection terminal through a second bypass unit. Thereby, when the voltage of the AC power connected with the light-emitting device increases, the voltages at the first connection terminal, the second connection terminal, and the third connection terminal can be varied in response to the variation of the reference voltage of the precedent light-emitting unit, so as to make the light-emitting device has more lighting stages and to achieve to be driven by the variable power source, and to acquire a higher efficiency of power-usage.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting device, which is connected with an alternating current (AC) power, comprising:
a first light-emitting module electrically connected with the AC power and comprising a first light-emitting unit and a first bypass unit in parallel connection with the first light-emitting unit; and
a second light-emitting module in series connection with the first light-emitting module and having a first connection terminal, a second connection terminal and n second light-emitting units connected in series between the first connection terminal and the second connection terminal, wherein n−1 third connection terminals are configured between the n second light-emitting units, and each of the n−1 third connection terminals and the second connection terminal is individually connected with the first connection terminal through a second bypass unit.

2. The light-emitting device of claim 1, further comprising:
a rectifier having an input terminal electrically connected with the AC power and an output terminal electrically connected with the first light-emitting module and the second light-emitting module.

3. The light-emitting device of claim 1, further comprising:
a current control circuit, wherein the current control circuit, the first light-emitting module, and the second light-emitting module form a series loop which is electrically connected with the AC power.

4. The light-emitting device of claim 3, wherein the current control circuit comprises a constant current source, an impedance component, or a current limiter.

5. The light-emitting device of claim 2, further comprising:
a current control circuit, wherein the current control circuit, the first light-emitting module, and the second light-emitting module form a series loop which is electrically connected with the AC power.

6. The light-emitting device of claim 1, further comprising:
a control module having a first control unit electrically connected with the first bypass unit, wherein the first control unit controls the first bypass unit so as to control the light emission of the first light-emitting unit.

7. The light-emitting device of claim 6, wherein the control module further comprises n second control units, and each of the n second control units is electrically connected with corresponding one of the second bypass units for controlling the light emission of the n second light-emitting units.

8. The light-emitting device of claim 7, wherein the second light-emitting module and the first light-emitting module have a junction located at the first connection terminal or at the second connection terminal, the first control unit detects the voltage at the junction so as to control the first bypass unit accordingly, each of the second control units detects the voltage of the first connection terminal, the second connection terminal, or the corresponding one among the n−1 third connection terminals so as to control each of the second bypass units accordingly.

9. The light-emitting device of claim 1, wherein each of the first light-emitting unit and the second light-emitting units comprises at least one light-emitting diode.

10. The light-emitting device of claim 1, wherein each of the first light-emitting unit and the second light-emitting units has a threshold voltage, and the threshold voltage of the first light-emitting unit is lower than that of the second light-emitting unit.

11. The light-emitting device of claim 10 wherein the threshold voltage of the first light-emitting unit substantially equals to half of the threshold voltage of one of the second light-emitting units.

12. The light-emitting device of claim 1, wherein each of the second light-emitting units has a plurality of light-emitting diodes connected in series of the same amount.

13. The light-emitting device of claim 8, wherein the first control unit controls the first bypass unit according to the potential difference between the voltage at the junction and a first reference voltage, and each of the second control units individually controls each of the second bypass units according to the potential difference between the corresponding one among n second reference voltages and the voltage of the first connection terminal, the second connection terminal, or the corresponding one among the n−1 third connection terminals.

14. The light-emitting device of claim 13, wherein the second control unit controls the corresponding second bypass unit to be not conducted and to make the corresponding second light-emitting unit emit light when the absolute voltage between the first connection terminal, the second connection terminal, or the corresponding one among the n−1 third connection terminal and the ground terminal is greater than the absolute value of the second reference voltage to the ground terminal, and when the absolute voltage of the first connection terminal, the second connection terminal, or the corresponding one among the n−1 third connection terminals to the ground terminal is lower than the absolute value of the second reference voltage to the ground terminal, the second control unit controls the corresponding second bypass unit to be conducted and to make the corresponding second light-emitting unit not emit light.

15. The light-emitting device of claim 1, further comprising:
a third light-emitting module, in series connection with the first light-emitting module, having a third light emitting unit and a third bypass unit in parallel connection with the third light-emitting unit, wherein the third light-emitting module and the first light-emitting module have a junction which is a fourth connection terminal.

16. The light-emitting device of claim 15, wherein each of the first light-emitting unit and the third light-emitting unit has a threshold voltage, and the threshold voltage of the third light-emitting unit is lower than that of the first light-emitting unit.

17. The light-emitting device of claim 15, wherein the control module further comprises a third control unit configured corresponding to the third bypass unit, and the third control unit detects the voltage at the fourth connection terminal and controls the third bypass unit accordingly so as to control the light emission of the third light-emitting unit.

18. The light-emitting device of claim 17, wherein the third control unit controls the third bypass unit according to the potential difference between the voltage at the fourth connection terminal and a third reference voltage.
